(19) United States
(12) Patent Application Publication
(10) Pub. No.: US 2005/0029298 A1
(43) Pub. Date: Feb. 10, 2005

(54) Bottled water dispenser stand

(76) Inventor: Conrad Sun, Encinitas, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/638,748

(22) Filed: Aug. 8, 2003

(51) Int. Cl. B67D 5/64

(52) U.S. Cl. 222/166

(57) ABSTRACT

A bottled water dispenser stand having a pivoting cradle for receiving an open bottle of water in an upright position and for dispensing water from the open mouth of the bottle by rotating the bottle about a pivot axis. The stand in a preferred embodiment comprises a pair of vertical members joined by at least one horizontal cross-member. The cradle comprises a cylindrical band which encircles the bottom region of the bottle and at least one bottle bottom support member which carries the weight of the bottle. The bottle bottom support member has two vertical struts extending upwardly and affixed to the cylindrical band. The vertical struts are rotatably attached to the vertical members of the stand for relative rotation or pivoting about an axis so that the cylindrical band and the bottle bottom support members can be tilted with the bottle for pouring water from the mouth of the bottle. A tilt control band is positioned about the upper periphery of the bottle. The tilt control band has a horizontally extending handle to facilitate ease of tilt control so that the tilt angle of the bottle can be precisely determined during dispensing of water. A pair of horizontally disposed leg members provide a stable base for the stand.

### BACKGROUND OF THE INVENTION

1. Field of the Invention

The present invention relates generally to the field of bottled water dispensers and more particularly to a free standing dispenser stand for holding large heavy water bottles in a pivoting cradle which controllably rotates the bottle to pour water from the open spout of the bottle.

2. Background Art

Five gallon water bottles are prolifically employed in offices and residences to provide high quality drinking water. Typically, they are deployed in liquid dispensers in the form of housings having a reservoir. The bottle is placed on top of the housing in an inverted position so that the reservoir is filled from the open mouth of the bottle partially emptying the bottle. Water from the reservoir is then selectively released in a controlled manner through a valved spout. After the bottle is emptied, it is removed from the housing and replaced by a full bottle which must be lifted to the height of the housing and inverted with an open mouth thereby risking spillage. Moreover, the housing tends to be large and bulky taking up a considerable amount of floor space. Furthermore, the reservoir and valve eventually collect bacteria and need to be cleaned or replaced periodically.

It would be advantageous to provide a bottled water dispenser which was easier to load with a full bottle, less bulky, less likely to require maintenance, of simple construction and less likely to cause spillage.

### SUMMARY OF THE INVENTION

The present invention comprises a bottled water dispenser stand having a pivoting cradle for receiving an open bottle of water in an upright position and for dispensing water from the open mouth of the bottle by rotating the bottle about a pivot axis. The stand in a preferred embodiment comprises a pair of vertical members joined by at least one horizontal cross-member. The cradle comprises a cylindrical band which encircles the bottom region of the bottle and at least one bottle bottom support member which carries the weight of the bottle. The bottle bottom support member has two vertical struts extending upwardly and affixed to the cylindrical band. The vertical struts are rotatably attached to the vertical members of the stand for relative rotation or pivoting about an axis so that the cylindrical band and the bottle bottom support members can be tilted with the bottle for pouring water from the mouth of the bottle. A tilt control band is positioned about the upper periphery of the bottle. The tilt control band has a horizontally extending handle to facilitate ease of tilt control so that the tilt angle of the bottle can be precisely determined during dispensing of water. A pair of horizontally disposed leg members provide a stable base for the stand. A second embodiment employs a cradle comprising upper and lower bands interconnected by a wire screen mesh cylinder for entirely surrounding the water bottle.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a three-dimensional view of a preferred embodiment of the invention with the bottle installed;

FIG. 2 is a three-dimensional view of the preferred embodiment without the bottle installed; and

FIG. 3 is a three-dimensional view of an alternative embodiment.

### DETAILED DESCRIPTION OF A PREFERRED EMBODIMENT

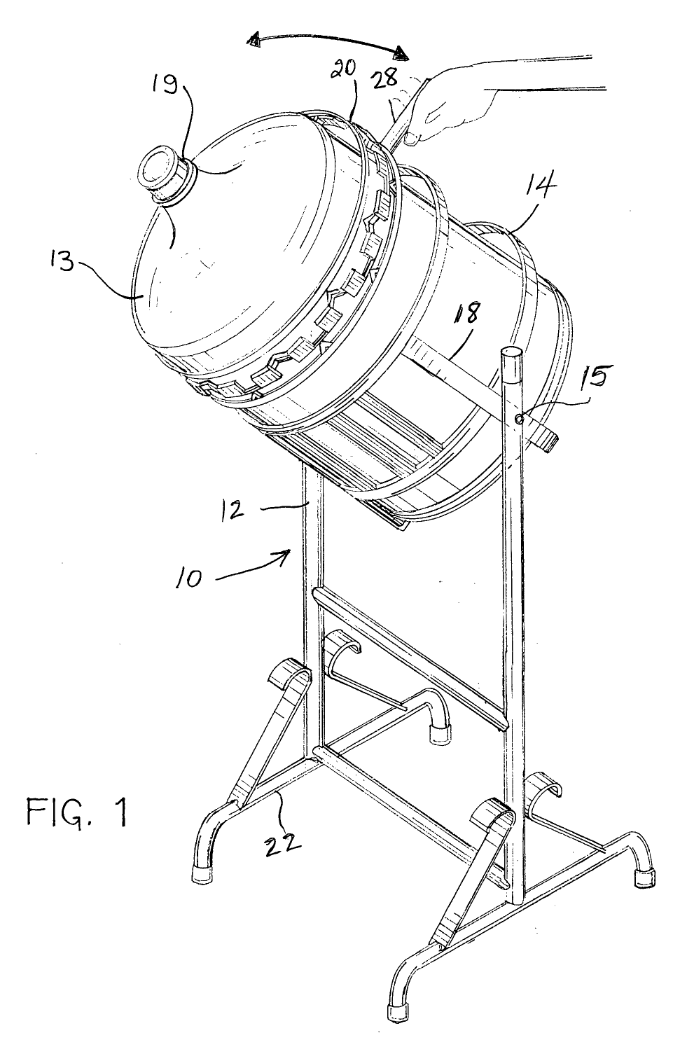

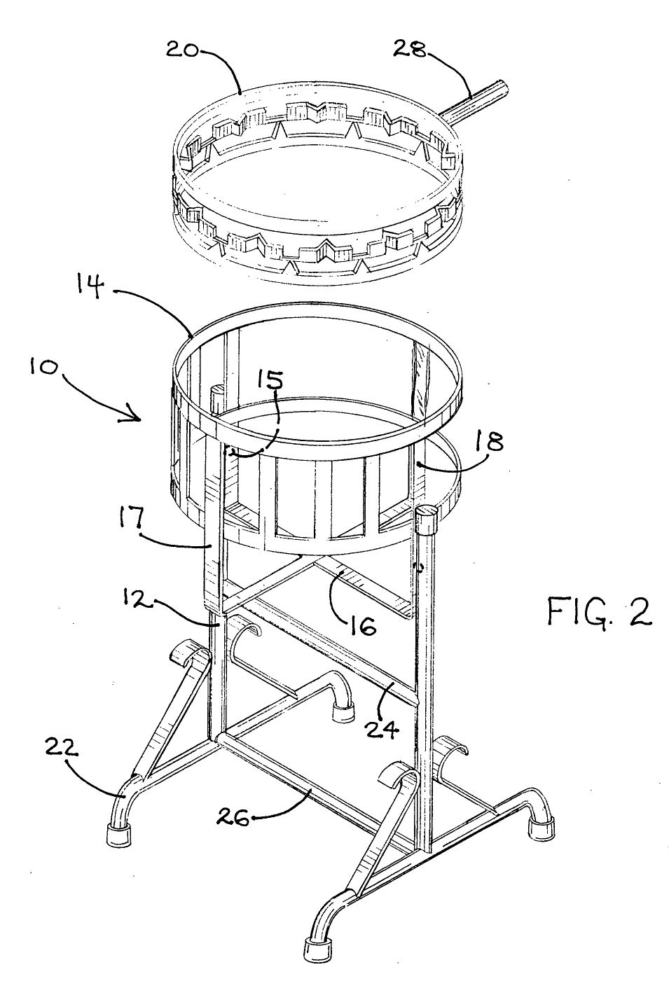

Referring to the accompanying drawings and FIGS. 1 and 2 in particular, it will be seen that a bottled water stand 10 has a pair of parallel extended vertical members 12 having horizontal cross-members 24 and 26. A cylindrical band 14 is designed to encircle a five gallon water bottle 13 having an open mouth 19. The band 14 is attached to a pair of orthogonal bottle bottom support members 16 via struts 17 and 18. Struts 18 are pivotally connected to the vertical members 12 at a tilt axis 15. The pivoting angle of the water bottle is controlled by a tilt control band 20 by means of an affixed handle 28. Band 20 may be made of a stretchable resilient material press fit around the upper end of the bottle. The stand 10 is stabilized by a pair of leg members 22 affixed to vertical members 12 below cross member 26.

It will be observed that water bottle 13 sits up-right in the stand 10 thereby avoiding the spillage problem of the prior art. It will also be seen that there is no need for a reservoir or valve operated spout and that the stand is far less massive and bulky than conventional bottled water dispensers.

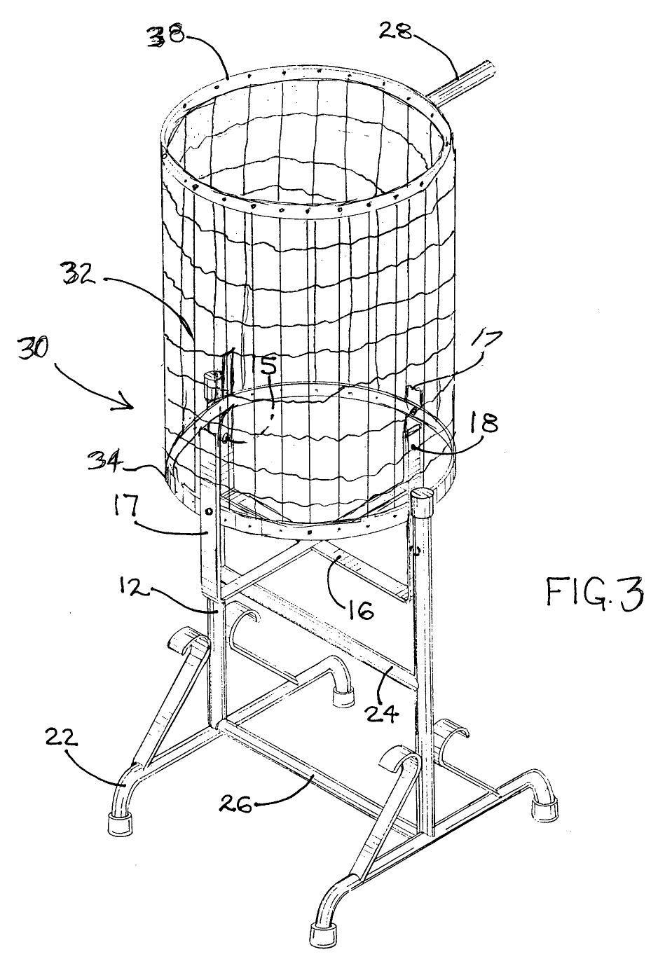

FIG. 3 illustrates an alternative embodiment in which the stand 30 comprises a wire mesh basket or cradle 32 having a lower band 34 and an upper band 38 for receiving a bottle 13. In other respects, the stand 30 is essentially the same as stand 10 of FIGS. 1 and 2.

Having thus disclosed a preferred embodiment of the invention, it will be understood that various modifications are contemplated. By way of example, the shape and dimensions of the various structural components may be altered without deviating from the salient features of the invention. Moreover, the precise mechanical characteristics of the bottle-holding mechanism may be readily altered. Therefore, the scope hereof is to be limited only by the appended claims and their equivalents.

1. A bottled water dispenser stand for holding a five gallon water bottle in an upright position and permitting dispensing of water from an open mouth of the bottle;
the stand comprising:
a pair of vertical members;
a cylindrical band for encircling the bottle;
at least one bottle bottom support member extending between said vertical members and having a pair of vertical struts pivotally connected to said vertical members and connected to opposing locations of said cylindrical band; and
a tilt control band press fit around the bottle above said cylindrical band and having a horizontally-extending handle.

2. A stand for supporting a water bottle and dispensing water therefrom; the stand comprising:
a pair of parallel elongated vertical support members; and
a cradle for receiving said water bottle in an upright position, said cradle being pivotally supported by said vertical support members for tilting said bottle for dispensing water from an open mouth of said bottle.

3. The stand recited in claim 2 further comprising a tilt control band encircling said bottle above said cradle and being graspable to control the extent of tilting of the bottle.

4. The stand recited in claim 3 wherein said tilt control band comprises a handle.

5. The stand recited in claim 2 wherein said cradle comprises a cylindrical band for supporting the radial surface of the bottle and at least one horizontal support member extending horizontally across said cylindrical band for supporting the bottom of the bottle.

6. The stand recited in claim 5 wherein said at least one horizontal support member comprises a pair of integral vertically extending struts that are pivotally mounted to said vertical support members for tilting said water bottle along a tilt axis.

7. The stand recited in claim 2 wherein said cradle comprises a cylindrical wire mesh basket having bands at respective upper and lower ends.

8. The stand recited in claim 7 wherein said cradle further comprises a handle extending from said band at said upper end of said basket.
